(19) United States
(12) Patent Application Publication
(10) Pub. No.: US 2014/0320966 A1
(43) Pub. Date: Oct. 30, 2014

(54) DEVICE FOR CAPTURING, TRANSMITTING AND DIFFUSING NATURAL LIGHT INTO INTERIOR SPACES, WHICH COMPRISES A CONDUIT OF INVERTED FRUSTOPYRAMIDAL FORM AND A DIFFUSER THAT EMERGES TRANSVERSELY WITH RESPECT TO THE HORIZONTAL PLANE OF THE CEILING OF A ROOM

(71) Applicant: UNIVERSIDAD DE CHILE, Santiago (CL)

(72) Inventors: Rebecca Jazmin Millaray Silva Roquefort, Santiago (CL); Maria Cecilia Wolff Cecchi, Santiago (CL)

(21) Appl. No.: 14/359,483

(22) PCT Filed: Dec. 12, 2012
(86) PCT No.: PCT/CL2012/000071

§ 371 Date: May 20, 2014

(30) Foreign Application Priority Data
Dec. 13, 2011 (CL) 3141-2011

(51) Int. Cl. F21S 11/00; G02B 5/02

(52) U.S. Cl. CPC F21S 11/002; F21S 11/007; G02B 5/0273
USPC 359/595

(57) ABSTRACT

A device of the skylight type for capturing, transmitting and diffusing natural light into the interior of a room, that comprises a duct configured as an inverted truncated pyramid made of a reflecting material having on its upper end a translucent plane adaptable to the conditions of the existing cover that receives the natural light. Given said duct material and configuration, the light is conducted by the inner walls of said duct to the lower end thereof, where it is joined to a light diffuser plate of a material having total internal reflection, said diffuser plate emerging transversely to the horizontal plane of the ceiling in the room that is going to be lighted. A connecting element provides a finish to the joint between said transmitting duct and said diffuser block. The device provides aesthetic and spatial characteristics that contribute light and ornamentation to the building, while being simple and easy to install.

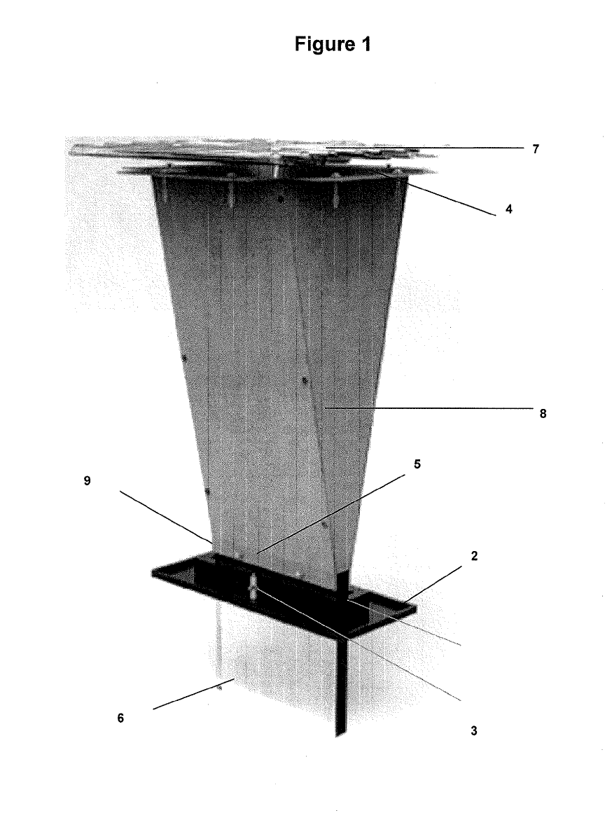

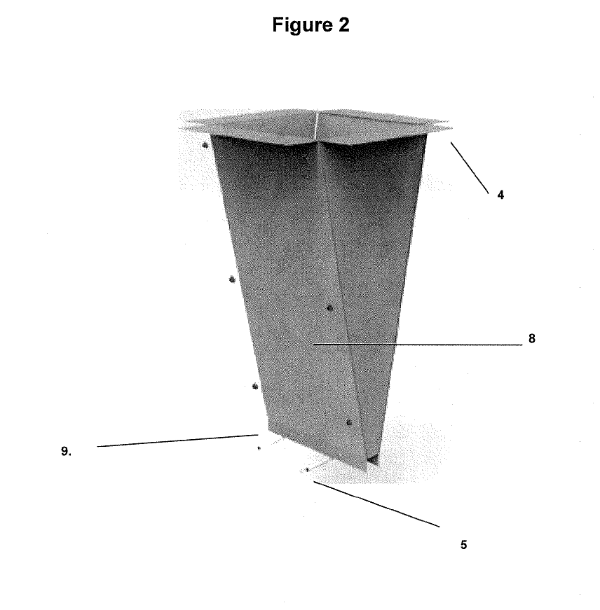

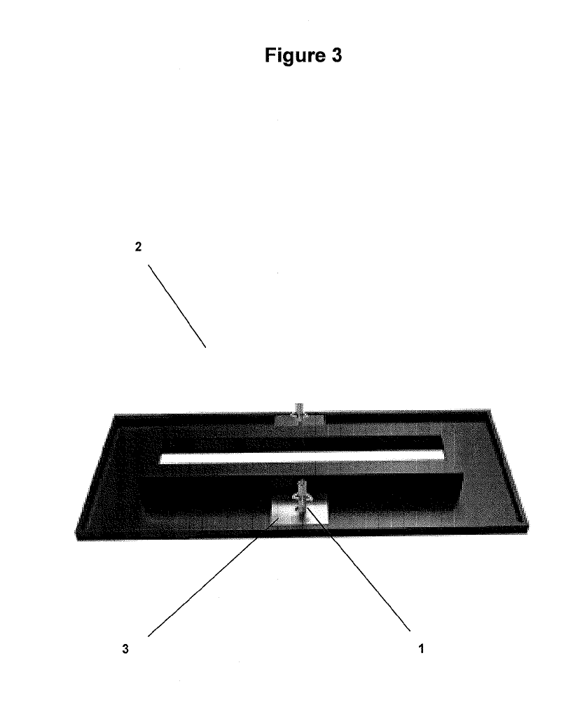

### FIELD OF THE UTILITY MODEL

The present utility model refers to a device for transmitting natural light that captures, conveys and diffuses the light into interior spaces. The utility model particularly refers to a device that captures, conveys and diffuses sunlight into interior spaces, contributing to light and ornament the building with a simple and easy to install design.

### BACKGROUND OF THE UTILITY MODEL

Built spaces, and mainly those spaces designated as secondary, such as bathrooms, hallways and family rooms, generally lack a direct access to natural light due to the absence of lateral or upper windows to make this possible. For this reason, these spaces are commonly lighted in the daytime by artificial light, thus causing economic damage and unfavorably affecting habitability and visual comfort.

When it is not possible to make an intervention with invasive procedures in an already built space in order to install skylights or windows, it is necessary then to seek new strategies. Thus it becomes necessary to develop devices that may convey natural light from the outside to those places where light does not penetrate, using the benefit they give as a means to provide an atmosphere, so as to light and revitalize the dark spaces. This proposal to modify already built spaces combined with the new illumination technologies should also provide characteristics of aesthetic and visual comfort, unlike those of the traditional fixtures for artificial lighting, should also be easy to install, and should be configured to allow using inexpensive materials.

In the state of the art there are devices that convey sunlight to poorly lighted spaces, capturing said light through a translucent plate or piece installed on the roof of a building. This plate is connected to a duct made of a reflecting material that conveys the light to the opposite end thereof where a light diffusing element is arranged installed on the ceiling of the room that is to be lighted with natural light. A great part of these inventions differ in the light capturing element that may be a flat plate or a translucent dome as disclosed in documents such as GB2400885, FR8813748, U.S. Pat. No. 6,604,329, US2002/0051297, U.S. Pat. No. 5,613,333 and U.S. Pat. No. 4,733,505.

With reference to the configuration of the duct that reflects and conveys the light from the capturing plate to the diffuser, the shapes commonly used are straight tubes, as in JP2011-119202, JP10-2011-0012982 and WO2010/070169; flexible tubes that allow to be easily adapted to the different angles existing between ceiling and roof—as in patents GB2431959, WO2007/140513, GB2425134, GB2400885, FR8813748 and U.S. Pat. No. 5,502,935; and configured as a truncated pyramid with the major base thereof in the diffuser area as in patents US2003/0126811, U.S. Pat. No. 6,363,667, U.S. Pat. No. 5,613,333.

Regarding the diffuser configuration, the use of diffuser plates horizontally oriented, convex or configured as domes is common to all inventions, as it may be appreciated in patents WO2011/071945, JP2011-119202, WO2010/070169, MX2009004706, WO2007/140513, GB2400885, FR8813748, US2011/0162304, U.S. Pat. No. 5,528,471, among others.

The present state of the art does not entirely solve either efficiently or effectively the technical problem associated with light conveyance. Neither does it solve the specific technical problem associated with the need to give a special appearance to the light diffuser element so that it may be identifiable or distinguishable from a lighting fixture powered by electricity, while not having an influence on the light intensity, color and quality. Finally, the specific technical problem associated with the difficulty of installing all the elements that configure the device has not yet been solved.

The solution proposed in this utility model corresponds to a device for transmitting natural light that captures, conveys and diffuses the light, with a design proposal that meets the aesthetic and spatial characteristics associated to comfort and perception of the users who are staying in the area where it is located.

The utility model comprises three sections: first a light transmitting duct configured as an inverted truncated pyramid, a diffuser block that emerges transversely to the horizontal plane of the ceiling and a connecting element to provide a finish to the joint between said transmitting duct and said diffuser block.

The main advantage of the device is its simple construction and installation that, without negatively altering the surroundings, allows solving an energetic need with ambient characteristics of quality, color and intensity of the emitted light that let the user perceive that the illumination is being supplied by sunlight and not by artificial light.

### DETAILED DESCRIPTION OF THE INVENTION

The present utility model consists in a sunlight capturing, transmitting and diffusing device that comprises a light capturing and transmitting duct configured as an inverted truncated pyramid (8) with properties of surface reflection, which at its upper end has a translucent plane that receives natural light, adaptable to the conditions of the existing cover; a diffuser block (6) that emerges transversely to the horizontal plane of the ceiling with properties of total internal reflection; and a connecting element that is placed against the ceiling to provide a finish to the joint between said transmitting duct and said diffuser block (2).

The device captures natural light through a translucent plate (7) located on the upper plane of the duct configured as an inverted truncated pyramid, placed against the room ceiling and connected to said duct by means of the pyramid upper flanges (4). Given the natural reflection produced on the surfaces of the reflecting material of said duct and by the angle of incidence provided by said duct configured as an inverted truncated pyramid, the light is conveyed to the opposite end of said duct where the lower longitudinal flanges (9) at the bottom of the pyramid are connected to a light diffusing plate (5). The diffuser block emerges transversely to the horizontal plane of the room ceiling in the manner of a ceiling lighting fixture. Finally, in order to secure the device and provide a suitable finish, the joint between said transmitting duct and said diffuser block is hidden with a plastic lower base (2) attached by screws (1) and a stainless steel fixing shim (3) to said diffuser block, defining a perimetric edge of the exposed block. In this way the block does not emerge abruptly from the ceiling

It must be noted that the diffuser block provides a distinguishable spatial and aesthetic appearance to the device, bestowing as well on the utility model distinctive ambient features of color and luminous intensity.

The simplicity of the device is reflected on the ease of installation thereof, which is mainly provided by the joint element between the diffuser block and the duct of reflecting material, where said joint is then hidden by a connecting element attached to the room ceiling. Said connecting element comprises a cavity traversed by said diffuser block and a space to allow attachment to said diffuser block.

The properties of the materials forming the different components are important for the device functionality. The diffuser block possesses the properties of total internal reflection present in materials such as glass, polymethyl-methacrylate, Plexiglas, optic fiber and transparent acrylic; the duct configured as an inverted truncated pyramid has properties of surface reflection that allow to conduct and convey light, present in materials such as acrylic, mirror glass and metals, as aluminum; whereas the transparent plate placed against said duct is made of materials such as glass, polycarbonate, transparent tile, polymethyl-methacrylate or acrylic.

The present utility model succeeds in making interventions in spaces, obtaining in turn constructive and functional benefits such as simplicity, ease of installation and accessibility of the materials used. It also procures the level, color, intensity and quality of the transmitted light that distinguish the innovation and allow to differentiate it in terms of the design proposal and related features associated with comfort and perception of the users who are staying in the area wherein it is located.

1. A device for capturing, transmitting and diffusing natural light into interior spaces that comprises:
a) a duct for capturing and transmitting light, configured as an inverted truncated pyramid with properties of surface reflection and having on its upper end a translucent plane adaptable to the conditions of the existing cover that receives natural light;
b) a diffuser block that rises transversely to the horizontal plane of the ceiling with properties of total internal reflection, and that is connected to the light capturing and transmitting duct at the end opposite to the translucent plane;
c) a connecting element to provide a finish to the joint between said transmitting duct and said diffuser block.

2. Device according to claim 1, wherein the connecting element comprises a cavity traversed by said diffuser block and a fastening element for attachment to said block.

3. Device according to claim 2, wherein said connecting element is placed against the ceiling.

4. Device according to claim 1, wherein a transparent cover is joined to said translucent plane.

5. Device according to claim 4, wherein the transparent cover is made of glass, polycarbonate, transparent tile, polymethyl-methacrylate or acrylic.

6. Device according to claim 1, wherein the light capturing and transmitting duct is made of materials that comprise acrylic, mirror glass or metal.

7. Device according to claim 6, wherein said metal is aluminum.

8. Device according to claim 1, wherein the diffuser block is of transparent acrylic, polymethyl-methacrylate, Plexiglas, optic fiber or glass,
